(19) United States
(12) Patent Application Publication
(10) Pub. No.: US 2026/0074244 A1
(43) Pub. Date: Mar. 12, 2026

(54) FUEL CELL MODULE

(71) Applicant: TOYOTA JIDOSHA KABUSHIKI KAISHA, Toyota-shi (JP)

(72) Inventor: Masaaki MATSUSUE, Mishima-shi (JP)

(73) Assignee: TOYOTA JIDOSHA KABUSHIKI KAISHA, Toyota-shi (JP)

(21) Appl. No.: 19/257,742

(22) Filed: Jul. 2, 2025

(30) Foreign Application Priority Data
Sep. 10, 2024 (JP) 2024-156945

(51) Int. Cl. H01M 8/04119; H01M 8/2457; H01M 8/2483

(52) U.S. Cl. CPC H01M 8/04156; H01M 8/04164; H01M 8/2457; H01M 8/2483

(57) ABSTRACT

A fuel cell module includes a fuel cell stack; a fuel gas outlet manifold that extends inside the fuel cell stack in a stacking direction, is configured such that a fuel gas that has passed through each of fuel-cell cells flows through the fuel gas outlet manifold, and includes a fuel gas discharge port on a first end surface of the fuel cell stack; an oxidant gas outlet manifold that extends inside the fuel cell stack in the stacking direction, is configured such that an oxidant gas that has passed through each of the fuel-cell cells flows through the oxidant gas outlet manifold, and includes an oxidant gas discharge port on a second end surface of the fuel cell stack; and a water drain flow passage that connects an upstream end portion of the fuel gas outlet manifold and the oxidant gas discharge port.

### CROSS-REFERENCE TO RELATED APPLICATION

This application claims priority to Japanese Patent Application No. 2024-156945 filed on Sep. 10, 2024. The disclosure of the above-identified application, including the specification, drawings, and claims, is incorporated by reference herein in its entirety.

### BACKGROUND

### 1. Technical Field

The technology disclosed in the present specification relates to a fuel cell module.

### 2. Description of Related Art

A fuel cell module disclosed in Japanese Unexamined Patent Application Publication No. 2007-042538 (JP 2007-042538 A) includes a fuel cell stack made up of a plurality of stacked fuel-cell cells. The fuel cell stack generates electricity by reacting a fuel gas with an oxidant gas. A fuel gas outlet manifold for discharging unreacted fuel gas and an oxidant gas outlet manifold for discharging unreacted oxidant gas are provided inside the fuel cell stack. The fuel gas outlet manifold and the oxidant gas outlet manifold extend in the stacking direction of the fuel-cell cells. Further, inside the fuel cell stack, water is generated by the reaction between the fuel gas and the oxidant gas. The generated water is discharged to the outside of the fuel cell stack from the fuel gas outlet manifold and the oxidant gas outlet manifold.

### SUMMARY

In the stacking direction, an outlet of the fuel gas outlet manifold may be provided on one end surface (hereinafter referred to as a first end surface) of the fuel cell stack, and an outlet of the oxidant gas outlet manifold may be provided on the other end surface (hereinafter referred to as the second end surface) of the fuel cell stack. In this case, when the fuel cell module is tilted in a direction in which the second end surface becomes below the first end surface, the fuel gas outlet manifold is tilted such that an upstream portion of the fuel gas outlet manifold goes down. Therefore, it is difficult for the generated water to be discharged from the fuel gas outlet manifold. The present specification proposes a fuel cell module that is easy to discharge generated water from the fuel gas outlet manifold.

A first fuel cell module disclosed in the present specification includes a fuel cell stack, a fuel gas outlet manifold, an oxidant gas outlet manifold, and a water drain flow passage. The fuel cell stack is made up of a plurality of stacked fuel-cell cells, and includes a first end surface on one side in a stacking direction of the fuel-cell cells and a second end surface on another side in the stacking direction. The fuel gas outlet manifold extends inside the fuel cell stack in the stacking direction, is configured such that a fuel gas that has passed through each of the fuel-cell cells flows through the fuel gas outlet manifold, and includes a fuel gas discharge port on the first end surface. The oxidant gas outlet manifold extends inside the fuel cell stack in the stacking direction, is configured such that an oxidant gas that has passed through each of the fuel-cell cells flows through the oxidant gas outlet manifold, and includes an oxidant gas discharge port on the second end surface. The water drain flow passage connects an upstream end portion of the fuel gas outlet manifold and the oxidant gas discharge port.

In the fuel cell module, when the fuel cell module is tilted and the second end surface becomes below the first end surface, the fuel gas outlet manifold is tilted and the upstream portion of the fuel gas outlet manifold goes down. Accordingly, the generated water in the fuel gas outlet manifold is discharged through the water drain flow passage to the oxidant gas discharge port. Therefore, in the fuel cell module, it is easy to discharge generated water from the fuel gas outlet manifold.

A second fuel cell module disclosed in the present specification includes a fuel cell stack, a fuel gas outlet manifold, an oxidant gas outlet manifold, a gas-liquid separator, and a first water drain pipe. The fuel cell stack is made up of a plurality of stacked fuel-cell cells, and includes a first end surface on one side in a stacking direction of the fuel-cell cells and a second end surface on another side in the stacking direction. The fuel gas outlet manifold extends inside the fuel cell stack in the stacking direction, is configured such that a fuel gas that has passed through each of the fuel-cell cells flows through the fuel gas outlet manifold, and includes a fuel gas discharge port on the first end surface. The oxidant gas outlet manifold extends inside the fuel cell stack in the stacking direction, is configured such that an oxidant gas that has passed through each of the fuel-cell cells flows through the oxidant gas outlet manifold, and includes an oxidant gas discharge port on the second end surface. The gas-liquid separator separates water from a fuel gas discharged from the fuel gas discharge port. The first water drain pipe extends from the gas-liquid separator through the first end surface, passes through the oxidant gas outlet manifold, and extends to the oxidant gas discharge port.

In the fuel cell module, the first water drain pipe through which water separated in the gas-liquid separator is discharged passes through the oxidant gas outlet manifold and extends to the oxidant gas discharge port. Therefore, the disposing route of the first water drain pipe is able to be shortened, and the fuel cell module is able to be made smaller.

In the first fuel cell module, a water drain pipe may be provided in the oxidant gas outlet manifold, and the water drain pipe may extend from an upstream end portion of the oxidant gas outlet manifold to the oxidant gas discharge port. An outlet of the water drain flow passage may be disposed upstream of an outlet of the water drain pipe in the oxidant gas outlet manifold.

With this configuration, the generated water in the oxidant gas outlet manifold is able to be easily discharged. In addition, flowing backward in the water drain flow passage is able to be suppressed.

In the second fuel cell module, a second water drain pipe may be provided in the oxidant gas outlet manifold, and the second water drain pipe may extend from an upstream end portion of the oxidant gas outlet manifold to the oxidant gas discharge port. An outlet of the first water drain pipe may be disposed upstream of an outlet of the second water drain pipe in the oxidant gas outlet manifold.

With this configuration, the generated water in the oxidant gas outlet manifold is able to be easily discharged. In addition, flowing backward in the first water drain pipe is able to be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view of a fuel cell module according to a first embodiment;

FIG. 2 shows the fuel cell module that is tilted;

FIG. 3 is a sectional view of a fuel cell module according to a second embodiment; and

FIG. 4 is a sectional view of a fuel cell module combining the first and second embodiments.

### DETAILED DESCRIPTION OF EMBODIMENTS

### First Embodiment

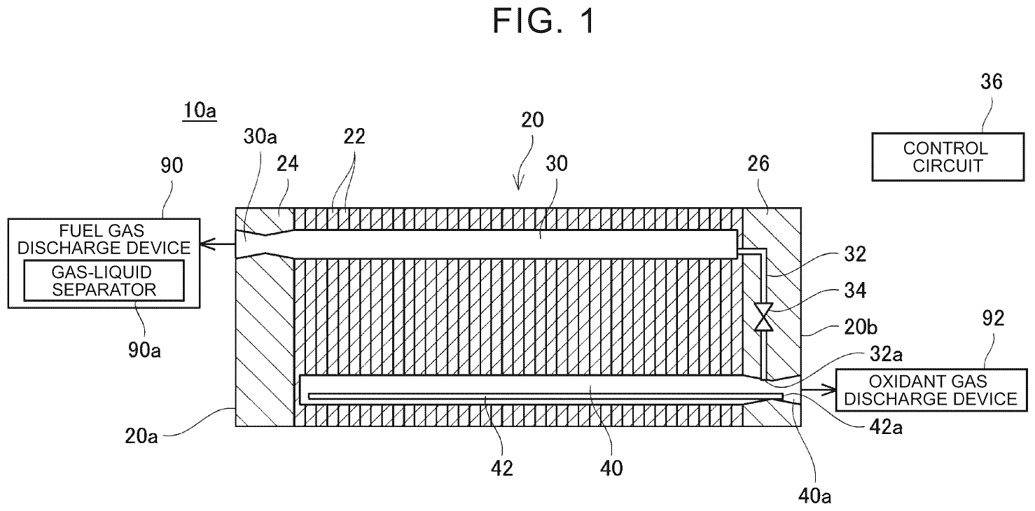

A fuel cell module 10a according to a first embodiment shown in FIG. 1 is mounted on an electrified vehicle. The fuel cell module 10a includes a fuel cell stack 20. The fuel cell module 10a supplies electric power generated in the fuel cell stack 20 to a drive motor of the electrified vehicle.

The fuel cell stack 20 includes a plurality of stacked fuel-cell cells 22 and end plates 24, 26. The fuel-cell cells 22 are stacked such that the stacking direction coincides with the horizontal direction in the electrified vehicle. In the stacking direction, both ends of the stack of the fuel-cell cells 22 are covered by the end plates 24, 26. That is, the stack of the fuel-cell cells 22 is disposed between the end plates 24, 26 in the stacking direction. In the following description, among both end surfaces of the fuel cell stack 20, the end surface on the end plate 24 side is referred to as a first end surface 20a, and the end surface on the end plate 26 side is referred to as a second end surface 20b.

A fuel gas and an oxidant gas are supplied to each of the fuel-cell cells 22 through a manifold (not shown). In the present embodiment, the fuel gas is hydrogen and the oxidant gas is air (more specifically, oxygen contained in the air). Each of the fuel-cell cells 22 generates electricity by reacting the fuel gas with the oxidant gas. As shown in FIG. 1, a fuel gas outlet manifold 30 and an oxidant gas outlet manifold 40 are provided inside the fuel cell stack 20.

The fuel gas outlet manifold 30 extends through each of the fuel-cell cells 22 inside the fuel cell stack 20 in the stacking direction. The fuel gas outlet manifold 30 includes a fuel gas discharge port 30a that penetrates the end plate 24 and opens to the first end surface 20a. The fuel gas discharge port 30a is connected to a fuel gas discharge device 90 mounted on the electrified vehicle. The fuel gas that has passed through each of the fuel-cell cells 22 flows through the fuel gas outlet manifold 30. Further, in each of the fuel-cell cells 22, water is generated by the reaction between the fuel gas and the oxidant gas. Each of the fuel-cell cells 22 discharges the generated water together with the fuel gas to the fuel gas outlet manifold 30. Therefore, the fuel gas and the generated water flow from the fuel gas outlet manifold 30 to the fuel gas discharge device 90. The fuel gas discharge device 90 includes a gas-liquid separator 90a. The fuel gas discharge device 90 separates the fuel gas from the generated water by the gas-liquid separator 90a, and supplies the separated fuel gas to the fuel cell stack 20 again. Further, the fuel gas discharge device 90 discharges the fuel gas that could not be separated from the generated water together with the generated water to the outside of the electrified vehicle.

The oxidant gas outlet manifold 40 extends through each of the fuel-cell cells 22 inside the fuel cell stack 20 in the stacking direction. The oxidant gas outlet manifold 40 includes an oxidant gas discharge port 40a that penetrates the end plate 26 and opens to the second end surface 20b. The oxidant gas discharge port 40a is connected to an oxidant gas discharge device 92 mounted on the electrified vehicle. The oxidant gas that has passed through each of the fuel-cell cells 22 flows through the oxidant gas outlet manifold 40. Further, each of the fuel-cell cells 22 discharges the generated water together with the oxidant gas to the oxidant gas outlet manifold 40. Therefore, the oxidant gas and the generated water flow from the oxidant gas outlet manifold 40 to the oxidant gas discharge device 92. The oxidant gas discharge device 92 discharges the oxidant gas together with the generated water to the outside of the electrified vehicle.

A water drain pipe 42 is provided within the oxidant gas outlet manifold 40. The water drain pipe 42 is a thin pipe that is thinner than the oxidant gas outlet manifold 40 and its both ends are open. The water drain pipe 42 extends from the upstream end portion (i.e., the first end surface 20a side) of the oxidant gas outlet manifold 40 to the oxidant gas discharge port 40a. When the generated water accumulates at the upstream end portion of the oxidant gas outlet manifold 40, the generated water is discharged through the water drain pipe 42 to the oxidant gas discharge port 40a. In this manner, the water drain pipe 42 promotes the discharge of the generated water in the oxidant gas outlet manifold 40.

A water drain flow passage 32 is provided inside the end plate 26. The water drain flow passage 32 is thinner than the fuel gas outlet manifold 30 and the oxidant gas outlet manifold 40. The upstream end of the water drain flow passage 32 is connected to the upstream end portion of the fuel gas outlet manifold 30. The downstream end of the water drain flow passage 32 is connected to the oxidant gas discharge port 40a. An outlet 32a of the water drain flow passage 32 is disposed upstream of an outlet 42a of the water drain pipe 42 in the oxidant gas outlet manifold 40. The water drain flow passage 32 is provided with a valve 34. The valve 34 is controlled by a control circuit 36.

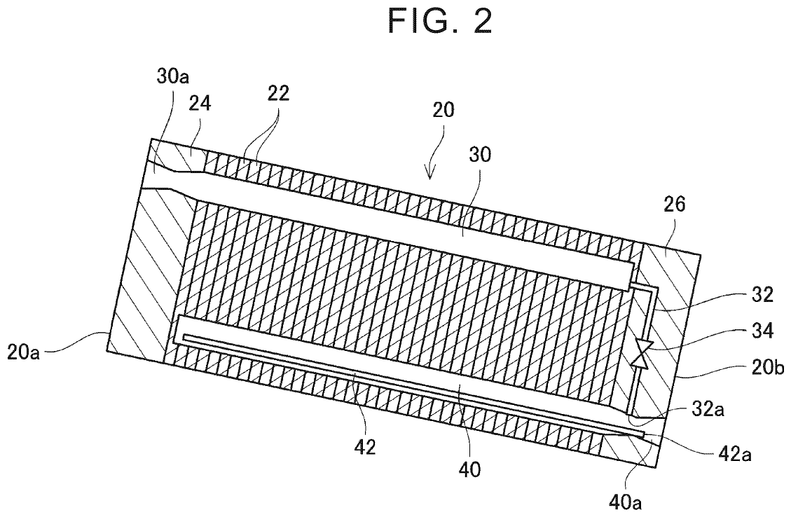

The control circuit 36 determines whether it is necessary to discharge the generated water through the water drain flow passage 32. For example, when the fuel cell module 10a is tilted as shown in FIG. 2 and the second end surface 20b is below the first end surface 20a due to tilting of the electrified vehicle etc., the generated water in the fuel gas outlet manifold 30 does not easily flow to the fuel gas discharge port 30a. When such a situation in which it is difficult to discharge the generated water from the fuel gas discharge port 30a occurs, the control circuit 36 determines that it is necessary to discharge the generated water through the water drain flow passage 32. When it is necessary to discharge the generated water through the water drain flow passage 32, the control circuit 36 determines whether the pressure in the fuel gas outlet manifold 30 is higher than the pressure in the oxidant gas outlet manifold 40. When the pressure in the fuel gas outlet manifold 30 is higher than the pressure in the oxidant gas outlet manifold 40, the control circuit 36 opens the valve 34. Accordingly, the generated water is discharged from the fuel gas outlet manifold 30 through the water drain flow passage 32 to the oxidant gas discharge port 40a. In this way, even when it is difficult to discharge the generated water from the fuel gas discharge port 30a, the generated water in the fuel gas outlet manifold 30 is able to be suitably discharged via the water drain flow passage 32. As described above, the outlet 32a of the water drain flow passage 32 is disposed upstream of the outlet 42a of the water drain pipe 42. This restrains the generated water discharged from the water drain pipe 42 from flowing backward to the water drain flow passage 32. Further, when the pressure in the fuel gas outlet manifold 30 is lower than the pressure in the oxidant gas outlet manifold 40, the control circuit 36 maintains the valve 34 in a closed state and does not discharge the generated water and the fuel gas through the water drain flow passage 32. This restrains the oxidant gas from flowing backward from the oxidant gas outlet manifold 40 through the water drain flow passage 32 to the fuel gas outlet manifold 30.

In the first embodiment, when the pressure in the fuel gas outlet manifold 30 is lower than the pressure in the oxidant gas outlet manifold 40, the control circuit 36 maintains the valve 34 in the closed state. In this case, however, the control circuit 36 may control the supply device of each gas so that the pressure in the fuel gas outlet manifold 30 is higher than the pressure in the oxidant gas outlet manifold 40. For example, the control circuit 36 may increase the pressure in the fuel gas outlet manifold 30 or decrease the pressure in the oxidant gas outlet manifold 40. The control circuit 36 may open the valve 34 after the pressure in the fuel gas outlet manifold 30 becomes higher than the pressure in the oxidant gas outlet manifold 40. Even in this configuration, the generated water can be discharged through the water drain flow passage 32 while the oxidant gas is restrained from flowing backward to the fuel gas outlet manifold 30.

In the first embodiment, the valve 34 is provided in the water drain flow passage 32. However, when the oxidant gas does not flow backward from the oxidant gas outlet manifold 40 to the fuel gas outlet manifold 30 (for example, when the flowing backward is restrained by another means) or when the flowing backward is not a problem, the valve 34 does not need to be provided in the water drain flow passage 32. That is, the water drain flow passage 32 may be always open in this case. Even in this configuration, the generated water is able to be discharged through the water drain flow passage 32.

### Second Embodiment

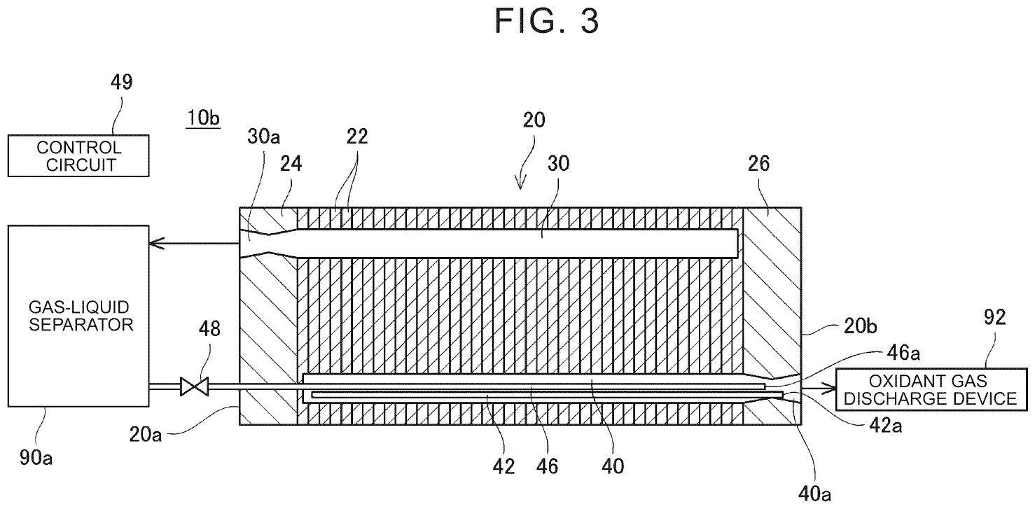

A fuel cell module 10b according to a second embodiment shown in FIG. 3 is mounted on an electrified vehicle. The fuel cell module 10b includes the fuel cell stack 20. The fuel cell module 10b supplies electric power generated in the fuel cell stack 20 to a drive motor of the electrified vehicle.

The fuel cell stack 20 includes a plurality of stacked fuel-cell cells 22 and the end plates 24, 26. The fuel-cell cells 22 are stacked such that the stacking direction coincides with the horizontal direction in the electrified vehicle. In the stacking direction, both ends of the stack of the fuel-cell cells 22 are covered by the end plates 24, 26. That is, the stack of the fuel-cell cells 22 is disposed between the end plates 24, 26 in the stacking direction. In the following description, among both end surfaces of the fuel cell stack 20, the end surface on the end plate 24 side is referred to as the first end surface 20a, and the end surface on the end plate 26 side is referred to as the second end surface 20b.

A fuel gas and an oxidant gas are supplied to each of the fuel-cell cells 22 through a manifold (not shown). In the present embodiment, the fuel gas is hydrogen and the oxidant gas is air (more specifically, oxygen contained in the air). Each of the fuel-cell cells 22 generates electricity by reacting the fuel gas with the oxidant gas. As shown in FIG. 3, the fuel gas outlet manifold 30 and the oxidant gas outlet manifold 40 are provided inside the fuel cell stack 20.

The fuel gas outlet manifold 30 extends through each of the fuel-cell cells 22 inside the fuel cell stack 20 in the stacking direction. The fuel gas outlet manifold 30 includes the fuel gas discharge port 30a that penetrates the end plate 24 and opens to the first end surface 20a. The gas-liquid separator 90a is disposed near the first end surface 20a. The fuel gas discharge port 30a is connected to the gas-liquid separator 90a. The fuel gas that has passed through each of the fuel-cell cells 22 flows through the fuel gas outlet manifold 30. Further, in each of the fuel-cell cells 22, water is generated by the reaction between the fuel gas and the oxidant gas. Each of the fuel-cell cells 22 discharges the generated water together with the fuel gas to the fuel gas outlet manifold 30. Therefore, the fuel gas and the generated water flow from the fuel gas outlet manifold 30 to the gas-liquid separator 90a. The gas-liquid separator 90a separates the fuel gas from the generated water, and supplies the separated fuel gas to the fuel cell stack 20 again.

The oxidant gas outlet manifold 40 extends through each of the fuel-cell cells 22 inside the fuel cell stack 20 in the stacking direction. The oxidant gas outlet manifold 40 includes the oxidant gas discharge port 40a that penetrates the end plate 26 and opens to the second end surface 20b. The oxidant gas discharge port 40a is connected to the oxidant gas discharge device 92 mounted on the electrified vehicle. The oxidant gas that has passed through each of the fuel-cell cells 22 flows through the oxidant gas outlet manifold 40. Further, each of the fuel-cell cells 22 discharges the generated water together with the oxidant gas to the oxidant gas outlet manifold 40. Therefore, the oxidant gas and the generated water flow from the oxidant gas outlet manifold 40 to the oxidant gas discharge device 92. The oxidant gas discharge device 92 discharges the oxidant gas together with the generated water to the outside of the electrified vehicle.

The water drain pipe 42 is provided within the oxidant gas outlet manifold 40. The water drain pipe 42 is a thin pipe that is thinner than the oxidant gas outlet manifold 40 and its both ends are open. The water drain pipe 42 extends from the upstream end portion (i.e., the first end surface 20a side) of the oxidant gas outlet manifold 40 to the oxidant gas discharge port 40a. When the generated water accumulates at the upstream end portion of the oxidant gas outlet manifold 40, the generated water is discharged through the water drain pipe 42 to the oxidant gas discharge port 40a. In this manner, the water drain pipe 42 promotes the discharge of the generated water in the oxidant gas outlet manifold 40.

A water drain pipe 46 is connected to the gas-liquid separator 90a. The water drain pipe 46 extends from the gas-liquid separator 90a through the first end surface 20a into the oxidant gas outlet manifold 40. The water drain pipe 46 extends from the gas-liquid separator 90a to the oxidant gas discharge port 40a. An outlet 46a of the water drain pipe 46 is disposed upstream of the outlet 42a of the water drain pipe 42 in the oxidant gas outlet manifold 40. As described above, the gas-liquid separator 90a separates the fuel gas from the generated water. The gas-liquid separator 90a discharges the fuel gas that has not been separated from the generated water and the generated water to the oxidant gas discharge port 40a via the water drain pipe 46. The water drain pipe 46 is provided with a valve 48. The valve 48 is controlled by a control circuit 49.

The control circuit 49 determines whether it is necessary to discharge the generated water through the water drain pipe 46. When it is necessary to discharge the generated water through the water drain pipe 46, the control circuit 49 determines whether the pressure in the gas-liquid separator 90a is higher than the pressure in the oxidant gas outlet manifold 40. When the pressure in the gas-liquid separator 90a is higher than the pressure in the oxidant gas outlet manifold 40, the control circuit 49 opens the valve 48. Accordingly, the generated water and the fuel gas are discharged from the gas-liquid separator 90a through the water drain pipe 46 to the oxidant gas discharge port 40a. The generated water and the fuel gas discharged from the water drain pipe 46 to the oxidant gas discharge port 40a are discharged to the outside of the electrified vehicle by the oxidant gas discharge device 92 together with the generated water and the oxidant gas in the oxidant gas outlet manifold 40. As described above, the outlet 46a of the water drain pipe 46 is disposed upstream of the outlet 42a of the water drain pipe 42. This restrains the generated water discharged from the water drain pipe 42 from flowing backward to the water drain pipe 46. Further, when the pressure in the gas-liquid separator 90a is lower than the pressure in the oxidant gas outlet manifold 40, the control circuit 49 maintains the valve 48 in a closed state and does not discharge the generated water and the fuel gas through the water drain pipe 46. This restrains the oxidant gas from flowing backward from the oxidant gas outlet manifold 40 through the water drain pipe 46 to the gas-liquid separator 90a.

As described above, in the second embodiment, the water drain pipe 46 that discharges the generated water and the fuel gas from the gas-liquid separator 90a extends through the end plate 24 and passes through the oxidant gas outlet manifold 40. According to the configuration, the disposing route of the water drain pipe 46 is able to be shortened than when the water drain pipe 46 is disposed outside the fuel cell stack 20, and the fuel cell module 10b is able to be made smaller.

In the second embodiment, when the pressure in the gas-liquid separator 90a is lower than the pressure in the oxidant gas outlet manifold 40, the control circuit 49 maintains the valve 48 in the closed state. In this case, however, the control circuit 49 may control the supply device of each gas so that the pressure in the gas-liquid separator 90a is higher than the pressure in the oxidant gas outlet manifold 40. For example, the pressure in the gas-liquid separator 90a may be increased, or the pressure in the oxidant gas outlet manifold 40 may be decreased. The control circuit 49 may open the valve 48 after the pressure in the gas-liquid separator 90a becomes higher than the pressure in the oxidant gas outlet manifold 40. Even in this configuration, the generated water can be discharged through the water drain pipe 46 while the oxidant gas is restrained from flowing backward to the gas-liquid separator 90a.

In the second embodiment, the valve 48 is provided in the water drain pipe 46. However, when the oxidant gas does not flow backward from the oxidant gas outlet manifold 40 to the gas-liquid separator 90a (for example, when the flowing backward is restrained by another means), the valve 48 does not need to be provided in the water drain pipe 46. That is, the water drain pipe 46 may be always open in this case.

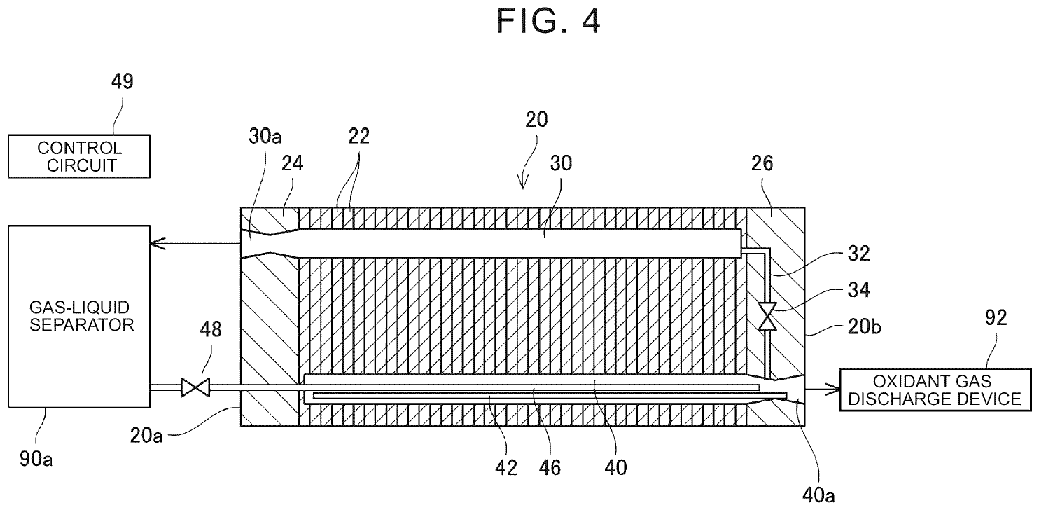

Further, as shown in FIG. 4, the first and second embodiments may be combined.

Although the embodiments have been described in detail above, these are merely examples and do not limit the scope of the claims. The technique described in the claims includes various modifications and variations of the specific examples exemplified above. The technical elements described in the present specification or in the drawings exhibit technical usefulness alone or in various combinations, and are not limited to the combinations described in the claims at the time of filing the application. In addition, the technique exemplified in the present specification or in the drawings achieves a plurality of purposes at the same time, and achieving one of the purposes itself has technical usefulness.

What is claimed is:

1. A fuel cell module comprising:
a fuel cell stack made up of a plurality of stacked fuel-cell cells, the fuel cell stack including a first end surface on one side in a stacking direction of the fuel-cell cells and a second end surface on another side in the stacking direction;
a fuel gas outlet manifold that extends inside the fuel cell stack in the stacking direction, is configured such that a fuel gas that has passed through each of the fuel-cell cells flows through the fuel gas outlet manifold, and includes a fuel gas discharge port on the first end surface;
an oxidant gas outlet manifold that extends inside the fuel cell stack in the stacking direction, is configured such that an oxidant gas that has passed through each of the fuel-cell cells flows through the oxidant gas outlet manifold, and includes an oxidant gas discharge port on the second end surface; and
a water drain flow passage that connects an upstream end portion of the fuel gas outlet manifold and the oxidant gas discharge port.

2. The fuel cell module according to claim 1, wherein:
a water drain pipe is provided in the oxidant gas outlet manifold, the water drain pipe extending from an upstream end portion of the oxidant gas outlet manifold to the oxidant gas discharge port; and
an outlet of the water drain flow passage is disposed upstream of an outlet of the water drain pipe in the oxidant gas outlet manifold.

3. A fuel cell module comprising:
a fuel cell stack made up of a plurality of stacked fuel-cell cells, the fuel cell stack including a first end surface on one side in a stacking direction of the fuel-cell cells and a second end surface on another side in the stacking direction;
a fuel gas outlet manifold that extends inside the fuel cell stack in the stacking direction, is configured such that a fuel gas that has passed through each of the fuel-cell cells flows through the fuel gas outlet manifold, and includes a fuel gas discharge port on the first end surface;
an oxidant gas outlet manifold that extends inside the fuel cell stack in the stacking direction, is configured such that an oxidant gas that has passed through each of the fuel-cell cells flows through the oxidant gas outlet manifold, and includes an oxidant gas discharge port on the second end surface;
a gas-liquid separator that separates water from a fuel gas discharged from the fuel gas discharge port; and
a first water drain pipe that extends from the gas-liquid separator through the first end surface, passes through the oxidant gas outlet manifold, and that extends to the oxidant gas discharge port.

4. The fuel cell module according to claim 3, wherein:
a second water drain pipe is provided in the oxidant gas outlet manifold, the second water drain pipe extending from an upstream end portion of the oxidant gas outlet manifold to the oxidant gas discharge port; and
an outlet of the first water drain pipe is disposed upstream of an outlet of the second water drain pipe in the oxidant gas outlet manifold.
